(19) United States
(12) Patent Application Publication
(10) Pub. No.: US 2019/0213241 A1
(43) Pub. Date: Jul. 11, 2019

(54) WEB PAGE DISPLAY METHOD AND APPARATUS, MOBILE TERMINAL, AND STORAGE MEDIUM

(71) Applicant: TENCENT TECHNOLOGY (SHENZHEN) COMPANY LIMITED, Shenzhen (CN)

(72) Inventor: Yulong YING, Shenzhen (CN)

(21) Appl. No.: 16/357,679

(22) Filed: Mar. 19, 2019

Related U.S. Application Data
(63) Continuation of application No. PCT/CN2017/107478, filed on Oct. 24, 2017.

(30) Foreign Application Priority Data
Nov. 14, 2016 (CN) 201611029648.7

(51) Int. Cl. G06F 17/22; G06F 16/957; G06F 17/27; G06F 3/0484; G06F 17/21

(52) U.S. Cl. CPC G06F 17/2247; G06F 16/957; G06F 17/272; H04W 88/02; G06F 17/227; G06F 17/212; G06F 17/2288; G06F 3/04847

(57) ABSTRACT

A web page display method and apparatus, a mobile terminal, and a storage medium are provided. The method includes: parsing source code of a specified web page requested to display, to obtain Document Object Model (DOM) tree information, JavaScript code, and at least two pieces of style rule information; determining a current display mode; and selecting style rule information corresponding to the current display mode from the at least two pieces of style rule information. The method also includes: executing the JavaScript code, to obtain a JavaScript execution result; and displaying the specified web page according to the DOM tree information, the JavaScript execution result, and the style rule information corresponding to the current display mode.

### RELATED APPLICATIONS

This application is a continuation application of PCT Patent Application No. PCT/CN2017/107478, filed on Oct. 24, 2017, which claims priority to Chinese Patent Application No. 201611029648.7, entitled “WEB PAGE DISPLAY METHOD AND APPARATUS” filed with the Patent Office of China on Nov. 14, 2016, the entire contents of both of which are incorporated herein by reference.

### FIELD OF TECHNOLOGY

Embodiments of the present disclosure relate to the field of Internet technologies, and in particular, to a web page display method and apparatus, a mobile terminal, and a storage medium.

### BACKGROUND OF THE DISCLOSURE

In modern life, many users are accustomed to browsing web pages on a browser. To meet browsing requirements of different users, at present, the browser provides two display modes: a display mode with pictures, and a display mode without pictures. In the display mode with pictures, the browser normally displays texts and pictures in web pages. In the display mode without pictures, the browser only displays texts in web pages, but does not display pictures in the web pages.

However, no matter whether the current display mode is the display mode with pictures or the display mode without pictures, the browser uses the default style rule information to display, but the default style rule information cannot meet display requirements of various display modes, so that a web page layout displayed according to the default style rule information is unreasonable, and cannot reflect the actual form of web pages.

### SUMMARY

Embodiments of the present disclosure provide a web page display method and apparatus, a mobile terminal, and a storage medium, to improve the reasonability of a web page layout, so that a displayed web page can reflect the actual form of web pages. The technical solutions are as follows:

According to a first aspect, a web page display method is provided. The method includes: parsing, by a mobile terminal, source code of a specified web page requested to display, to obtain Document Object Model (DOM) tree information, JavaScript code, and at least two pieces of style rule information; determining, by the mobile terminal, a current display mode; and selecting, by the mobile terminal, style rule information corresponding to the current display mode from the at least two pieces of style rule information. The method also includes executing the JavaScript code, to obtain a JavaScript execution result; and displaying the specified web page according to the DOM tree information, the JavaScript execution result, and the style rule information corresponding to the current display mode.

According to a second aspect, a web page display apparatus is provided. The apparatus includes: a memory and a processor coupled to the memory. The processor is configured to parse source code of a specified web page requested to display, to obtain Document Object Model (DOM) tree information, JavaScript code, and at least two pieces of style rule information; determine a current display mode; and select style rule information corresponding to the current display mode from the at least two pieces of style rule information. The processor is also configured to execute the JavaScript code, to obtain a JavaScript execution result; and display the specified web page according to the DOM tree information, the JavaScript execution result, and the style rule information corresponding to the current display mode.

According to a third aspect, a mobile terminal configured to display a web page is provided, and includes: one or more processors and a memory, the memory being configured to store at least one instruction, at least one program, and a code set or an instruction set, and the at least one instruction, and the at least one program, and the code set or the instruction set being loaded by the processor and implementing the web page display method according to the first aspect.

According to a fourth aspect, a non-transitory storage medium storing computer program instructions. The computer program instructions executable by at least one processor to perform parsing source code of a specified web page requested to display, to obtain Document Object Model (DOM) tree information, JavaScript code, and at least two pieces of style rule information; determining a current display mode; and selecting style rule information corresponding to the current display mode from the at least two pieces of style rule information. The computer program instructions also cause the at least one processor to perform: executing the JavaScript code, to obtain a JavaScript execution result; and displaying the specified web page according to the DOM tree information, the JavaScript execution result, and the style rule information corresponding to the current display mode.

The technical solutions provided in the embodiments of the present disclosure have the following beneficial effects:

A current display mode is determined, and style rule information corresponding to the current display mode is selected according to the current display mode, to meet display requirements in different display modes, so that a displayed web page layout is more reasonable, and can reflect the actual form of web pages.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show merely some embodiments of the present disclosure, and a person of ordinary skill in the technology may still derive other drawings from these accompanying drawings without creative efforts.

FIG. 1 is a flowchart of a web page display method according to an embodiment of the present disclosure;

FIG. 2 is a schematic diagram of a web page display process according to an embodiment of the present disclosure;

FIG. 3 is a schematic diagram of a web page display process according to an embodiment of the present disclosure;

FIG. 4 is a schematic structural diagram of a web page display apparatus according to an embodiment of the present disclosure; and

FIG. 5 shows a schematic structural diagram of a mobile terminal that displays a web page according to an embodiment of the present disclosure.

### DESCRIPTION OF EMBODIMENTS

To make the objectives, technical solutions, and advantages of the embodiments of the present disclosure clearer, the following further describes implementations of the present disclosure in detail with reference to the accompanying drawings.

In modern society, a mobile terminal gradually becomes a part of a user's life. The user is accustomed to browsing web pages on a browser in leisure time to killing time. Generally, the web pages browsed by the user include some pictures, and when the browser is downloading the pictures, not only a lot of traffic is consumed, but a web page downloading speed is lowered.

At present, the browser provides two display modes: a display mode without pictures and a display mode with pictures. In the display mode without pictures, the browser only displays texts in web pages, but does not display pictures in the web pages. In the display mode with pictures, the browser normally displays texts and all pictures in web pages. Based on the two display modes, the user may select a corresponding display mode according to customized traffic and a current network scenario. However, no matter which display mode the user selects, the browser only performs displaying according to default style rule information. The default style rule information cannot meet display requirements of various display modes. For example, at present, many web pages do not specify a width and height attribute of a picture node, so that picture node information in DOM tree information obtained through parsing does not include the width and height attribute of the picture node. In the display mode without pictures, because the browser does not load picture resources, when web pages are being displayed, only stretching in equal proportion can be performed according to the width and height of web pages in a screen of a mobile terminal, to obtain a display area of the picture node. The display area is different from a display area indicated by actual node information. In other words, the current technology for handling display mode without pictures does not provide interaction capabilities with front-end web interface. The front-end web page or front-end of the browser is not aware of the current display mode and cannot automatically or actively adjust the layout accordingly. That is, the browser may not understand the display layout of the page (e.g., intention of the page creator/developer, how the page is supposed to look like) and render undesired results for display. By combining the foregoing two reasons, a web page layout rendered in the related technology is unreasonable.

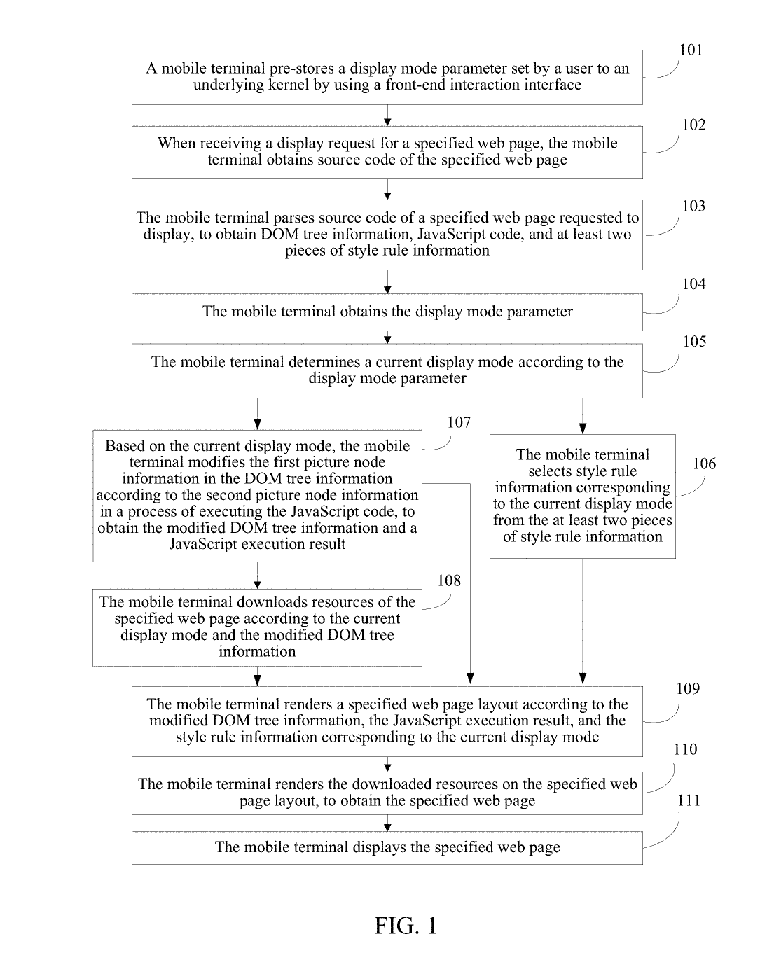

To resolve the problem in the related technology, an embodiment of the present disclosure provides a web page display method. For example, a mobile terminal is used to execute one embodiment of the present disclosure. Referring to FIG. 1, a process of the method provided in one embodiment of the present disclosure includes:

101. A mobile terminal pre-stores a display mode parameter set by a user to an underlying kernel by using a front-end interaction interface.

The mobile terminal may be a device such as a smart phone, a tablet computer, or a notebook computer, the mobile terminal is installed with a browser, and with the installed browser, a user may browse web pages in the mobile terminal.

To meet browsing requirements of the user, the browser of the mobile terminal provides various display modes, including a display mode without pictures, a display mode with pictures, a display mode without pictures in a data network, and the like. When the browser is in the display mode without pictures, no matter which network status the mobile terminal is in, and no matter whether pictures in the web pages are buffered in a local memory of the mobile terminal, the browser of the mobile terminal only displays texts in the web pages, but does not display pictures in the web pages. When the browser is in the display mode with pictures, no matter which network status the mobile terminal is in, and no matter whether pictures in the web pages are buffered in a local memory of the mobile terminal, the browser of the mobile terminal may normally display texts and all pictures in the web pages. When the browser is in the display mode without pictures in a data network, if the mobile terminal is in a WiFi network, the browser of the mobile terminal may normally display texts and all pictures in the web pages, and if the mobile terminal is in a data network, the browser of the mobile terminal may normally display pictures buffered in a local memory, and, the browser of the mobile terminal cannot display pictures not buffered in the local memory. The local memory may be at least one of a volatile memory (such as a memory) and a non-volatile memory (such as a hard disk).

Considering strengths of WiFi signals of different users are different, to meet a rapid browsing requirement of a user in a weak WiFi signal, in addition to the foregoing three display modes, one embodiment of the present disclosure further provides a display mode without pictures in a WiFi network.

In one embodiment of the present disclosure, a front-end interaction interface is preset in the browser of the mobile terminal, and the front-end interaction interface may be located in an underlying kernel of the browser, or may be located at a front end of the browser. A specific position of the front-end interaction interface is not specifically limited in one embodiment of the present disclosure. The front-end interaction interface is mainly used at the front end of the browser to interact with the underlying kernel, and has functions of providing a web page event notification, calling an attribute, triggering a CSS style selector, and the like. As used herein, the front end of the browser may refer to an inherent component of the browser application that handles rendering and displaying of a requested web page and processing user interactions on graphical interface of the browser application. The front-end interaction interface may refer to a unique component of the browser application developed to achieve the technical solution in accordance with various embodiments of the present disclosure. By providing an interaction capability between the front end of the browser and the underlying kernel, the front end of the browser can sense a change of the display mode, and actively adjust the web page layout for the change of the display mode, so that the web page layout in different display modes can reflect the actual form of the web pages.

After the browser of the mobile terminal is started, the user may set the display mode of the browser on a browser interface, and the browser of the mobile terminal detects a mode setting operation of the user on the browser interface, to obtain a display mode parameter corresponding to the display mode set by the user, and sends the obtained display mode parameter to the underlying kernel by using the preset front-end interaction interface for storage. The display mode parameter includes whether to download pictures, whether to display pictures, and the like. If the display mode set by the user is the display mode with pictures, the display mode parameter corresponding to the display mode with pictures is: downloading pictures and displaying pictures; if the display mode set by the user is the display mode without pictures, the display mode parameter corresponding to the display mode without pictures is not downloading pictures and not displaying pictures; if the display mode set by the user is the display mode without pictures in a data network, the display mode parameter corresponding to the display mode without pictures in a data network is: not downloading pictures and displaying pictures, pictures buffered in the local memory can be displayed in the data network, and pictures can be downloaded and the downloaded pictures can be displayed in a WiFi network.

102. When receiving a display request for a specified web page, the mobile terminal obtains source code of the specified web page.

In a process of starting the browser, the user may click, according to a reading requirement of the user, a specified web page link displayed on the browser of the mobile terminal, and when detecting the clicking operation of the user for the specified web page link, the browser of the mobile terminal may generate a display request for the specified web page. By triggering the display request for the specified web page, the mobile terminal may obtain source code of the specified web page from a server. Certainly, if the local memory of the mobile terminal stores the specified web page, the mobile terminal may further obtain the source code of the specified web page from the local memory. The display request for the specified web page at least carries attribute information of the specified web page, and includes a web page identifier, a web page type, a web page size, and the like.

103. The mobile terminal parses source code of a specified web page requested to display, to obtain DOM tree information, JavaScript code, and at least two pieces of style rule information.

By triggering the display request for the specified web page, the browser of the mobile terminal may perform HTML parsing, JavaScript parsing, and CSS parsing on the specified web page.

The mobile terminal may perform HTML parsing on the source code of the specified web page, to obtain DOM tree information of the specified web page. A DOM tree refers to a tree structure that includes an element, an attribute, and a text and that is obtained by parsing web pages, and each node in the tree structure has an attribute of including some information of this node. The DOM tree information includes first picture node information and text node information of the specified web page. The first picture node information includes position information, dimension information, the size and the color, and the like of the pictures in the specified web page. The text node information includes the position, the size, the font, the color, and the like of the texts in the specified web page.

The mobile terminal may perform JavaScript parsing on the source code of the specified web page, to obtain JavaScript code, where the JavaScript code carries second picture node information. Because JavaScript parsing is a dynamic parsing manner, attribute information of the web pages may be obtained in real time from the specified web page in a parsing process. The web page attribute information includes all information of the specified web page, such as picture node information. Therefore, the second picture node information obtained through JavaScript parsing is more accurate than the first picture node information obtained through HTML parsing, and is actual picture node information of the specified web page.

The style rule information is mainly used to determine display characteristics such as the color, the font, the typesetting, and the like of the specified web page. The mobile terminal may perform Cascading Style Sheets (CSS) parsing on the source code of the specified web page, to obtain at least two pieces of style rule information, and the at least two pieces of style rule information correspond to the display mode supported by the browser, including style rule information corresponding to the display mode without pictures, style rule information corresponding to the display mode with pictures, and style rule information corresponding to the display mode without pictures in a data network. The at least two pieces of style rule information may be used by the browser of the mobile terminal to adjust the specified web page layout in different display modes.

104. The mobile terminal obtains the display mode parameter.

In one embodiment of the present disclosure, the display mode parameter is stored in the underlying kernel of the browser, and the browser of the mobile terminal may obtain the display mode parameter from the underlying kernel of the browser by using the front-end interaction interface.

105. The mobile terminal determines a current display mode according to the display mode parameter.

Because different display mode parameters can reflect different display modes, the browser of the mobile terminal may determine the current display mode according to the obtained display mode parameter. If the obtained display mode parameter is not downloading pictures and not displaying pictures, it may be determined that the current display mode is the display mode without pictures. If the obtained display mode parameter is downloading pictures and displaying pictures, it may be determined that the current display mode is the display mode with pictures. If the obtained display mode parameter is not downloading pictures and displaying pictures, it may be determined that the current display mode is the display mode without pictures in a data network. For the display mode without pictures in a data network, when pictures are actually displayed, a current network status of the mobile terminal needs to be further determined, and resources in the specified web page are displayed according to the current network status and whether the local memory buffers the pictures.

106. The mobile terminal selects style rule information corresponding to the current display mode from the at least two pieces of style rule information, and performs step 109.

When the current display mode is determined according to the display mode parameter, the browser of the mobile terminal may trigger a CSS selector by using the front-end interaction interface, and select the style rule information corresponding to the current display mode from multiple pieces of style rule information. If the current display mode is the display mode with pictures, the style rule information corresponding to the display mode with pictures is obtained. If the current display mode is the display mode without pictures, the style rule information corresponding to the display mode without pictures is obtained. If the current display mode is the display mode without pictures in a data network, the style rule information corresponding to the display mode without pictures in a data network is obtained.

The browser of the mobile terminal selects the style rule information corresponding to the current display mode, so that a same web page in different display modes may be displayed by using different style rule information, to meet display requirements in different display modes.

107. Based on the current display mode, the mobile terminal modifies the first picture node information in the DOM tree information according to the second picture node information in a process of executing the JavaScript code, to obtain the modified DOM tree information and a JavaScript execution result, and performs step 108 and step 109.

For the process for the browser of the mobile terminal to modify the first picture node information in the DOM tree information, reference may be made to the following steps:

First step. The mobile terminal registers a call interface function with the front-end interaction interface.

In one embodiment, after performing JavaScript parsing on the source code of the specified web page, the browser of the mobile terminal further registers a call interface function with the front-end interaction interface. The call interface function includes second picture node information and data used to trigger the execution of the JavaScript code, and may trigger the browser of the mobile terminal to modify the first picture node information in the DOM tree information in the process of executing the JavaScript code.

Second step. The browser of the mobile terminal calls back the call interface function registered in advance by using the front-end interaction interface.

The call interface function may include code used to indicate a calling chance of the browser for the front-end interaction interface, and may further include the second picture node information, and the like.

Third step. The browser of the mobile terminal may modify the first picture node information in the DOM tree information according to the second picture node information in the process of executing of the JavaScript code by using the call interface function, to obtain the modified DOM tree information, and obtain a JavaScript execution result. The JavaScript execution result may be a script.

During specific implementation, the browser of the mobile terminal may be triggered to modify the first picture node information in the DOM tree information according to the second picture node information in the process of executing the JavaScript code when the call interface function is called back, to obtain the modified DOM tree information. The browser of the mobile terminal may further modify the first picture node information in the DOM tree information according to the second picture node information in the call interface function in the process of executing of the JavaScript code, to obtain the modified DOM tree information.

The process for the browser of the mobile terminal to modify the first picture node information in the DOM tree information according to the second picture node information in the JavaScript code is: The browser of the mobile terminal compares position information in the second picture node information with position information in the first picture node information when executing the JavaScript code, and if they are different, the position information in the first picture node information is modified according to the position information in the second picture node information; the mobile terminal further compares dimension information in the second picture node information with dimension information in the first picture node information, and if they are different, the dimension information in the first picture node information is modified according to the dimension information in the second picture node information; the mobile terminal further compares the size of the picture in the second picture node information with the size of the picture in the first picture node information, and if they are different, the size of the picture in the first picture node information is modified according to the size of the picture in the second picture node information; the mobile terminal further compares color information in the second picture node information with color information in the first picture node information, and if they are different, the color information in the first picture node information is modified according to the color information in the second picture node information.

Certainly, not only the front-end interaction interface is used to trigger the mobile terminal to modify the first picture node information in the DOM tree information in the process of executing the JavaScript code, other manners may also be used. This is not specifically in one embodiment of the present disclosure.

108. The mobile terminal downloads resources of the specified web page according to the current display mode and the modified DOM tree information.

In one embodiment of the present disclosure, the display mode of the browser includes a display mode with pictures, a display mode without pictures, and a display mode without pictures in a data network. For the three display modes, when the mobile terminal downloads the resources in the specified web page according to the current display mode and the modified DOM tree information, it may be divided into the following three cases:

First case. The current display mode is the display mode with pictures.

In the display mode with pictures, the browser of the mobile terminal traverses the text node information in the modified DOM tree information, and downloads the text resources one by one according to the text node information in the modified DOM tree information. Meanwhile, the browser of the mobile terminal traverses the first picture node information in the modified DOM tree information, and downloads the picture resources one by one according to the first picture node information in the modified DOM tree information.

Based on the downloaded picture resources, the browser of the mobile terminal further decodes the downloaded picture resources, to obtain picture attribute information. The picture attribute information includes the size of the picture, the dimension of the picture, the position of the picture, and the like.

Further, to improve the web page downloading speed, in the display mode with pictures, the browser of the mobile terminal may further predict/identify a picture display area. The picture display area has the determined dimension, display position, background color, and the like. During specific prediction, the browser of the mobile terminal may predict the picture display area according to the picture attribute information, or may predict the picture display area according to the second picture node information in the modified DOM tree information. In the process, because the picture attribute information obtained through parsing and the first picture node information in the modified DOM tree information can accurately reflect the actual situation of the picture, no matter which manner (e.g., display mode) is used, the predicted picture display area is an actual picture display area of the picture (e.g., regardless of whether the picture is actually loaded and displayed in the picture display area, the picture display area itself, such as its position and/or size within the webpage, may be reserved or kept. For example, in the display mode without pictures, the picture display area may appear as a blank block or other suitable style in the webpage).

Second case. The current display mode is the display mode without pictures.

In the display mode without pictures, the browser of the mobile terminal traverses the text node information in the modified DOM tree information, and downloads the text resources one by one according to the text node information in the modified DOM tree information, but does not download the picture resources according to the first picture node information in the modified DOM tree information.

Further, to improve the web page downloading speed, in the display mode without pictures, the browser of the mobile terminal may further predict a picture display area. The picture display area has the determined dimension, display position, background color, and the like. During specific prediction, the browser of the mobile terminal may predict the picture display area according to the first picture node information in the modified DOM tree information. A specific process is as follows:

First step. The browser of the mobile terminal determines the actual dimension and the display position of the picture according to the modified first picture node information.

Second step. The browser of the mobile terminal draws a picture display area on the determined display position by using an actual dimension as a boundary area and by using a specified color as a fill color, and uses the drawn picture display area as the predicted picture display area. The specified color may be gray, black, or the like.

Third case. The current display mode is the display mode without pictures in a data network.

In the display mode without pictures in a data network, the mobile terminal needs to determine a current network status, to display the specified web page according to the current network status. Specifically, the mobile terminal may determine whether the current network status is a WiFi network (or WiFi network connection) according to whether the mobile terminal is connected to the WiFi network, if the mobile terminal is connected to the WiFi network, it may be determined that the current network status is the WiFi network connection, and execute the foregoing first case, to download the text resources and the picture resources according to the display mode with pictures; and if the mobile terminal is not connected to the WiFi network, and a cellular mobile data option is in a started status, it may be determined that the current network status is a data network (or cellular data network connection).

When the current network status is the cellular data network connection, the mobile terminal may switch from a WiFi network scenario to a data network scenario, and in the switching process, some or all picture resources may be stored in the local memory. Therefore, in the data network, the mobile terminal needs to traverse the first picture node information in the modified DOM tree information, to further determine whether picture resources corresponding to the picture nodes are buffered/cached in the local memory. If all picture resources of the specified web page are buffered in the local memory, the browser of the mobile terminal may execute the foregoing first case, to download the text resources according to the display mode with pictures, and obtain the buffered/cached picture resources, to further display the buffered picture resources according to the display mode with pictures. If the picture resources of the specified web page are not buffered in the local memory, the browser of the mobile terminal may execute the foregoing second case, to download the text resources according to the display mode without pictures, to further display the text resources according to the display mode without pictures. If the local memory buffers some picture resources in the specified web page, the buffered picture resources may be displayed according to the display mode with pictures, and the picture resources not buffered may be displayed according to the display mode without pictures.

Certainly, if the current network status is the data network, no matter whether the local memory buffers the picture resources, to reduce resources, the buffered picture resources may not be displayed.

109. The mobile terminal renders a specified web page layout according to the modified DOM tree information, the JavaScript execution result, and the style rule information corresponding to the current display mode.

The browser of the mobile terminal runs the JavaScript execution result, operates the modified DOM tree information and the style rule information corresponding to the current display mode, to generate a Rendering tree, and renders the specified web page layout according to the Rendering tree by calling an API (Application Programming Interface) of a Native GUI (Graphical User Interface) of an operating system. The Rendering tree is used to determine layouts of a picture nodes and text nodes, and render the picture nodes and the text nodes to a screen of the mobile terminal as pixels. The specified web page layout includes a text display area and a picture display area, the text display area is used to display text resources in web pages, and the picture display area is used to display picture resources in web pages. Because the first picture node information in the modified DOM tree information is accurate picture node information, and the style rule information can reflect the display requirement of the current display mode, the specified web page layout rendered according to the modified DOM tree information, the JavaScript execution result, and the style rule information corresponding to the current display mode is more reasonable.

Certainly, if the browser of the mobile terminal predicts picture display areas for different display modes, when rendering the specified web page layout, the browser of the mobile terminal may further render the specified web page layout according to the predicted picture display area, to improve the rendering speed of the web page layout.

110. The mobile terminal renders the downloaded resources on the specified web page layout, to obtain the specified web page.

Because the browser of the mobile terminal can download different resources in different display modes, for different display modes, when the browser of the mobile terminal renders the downloaded resources in different areas of the specified web page layout, it may be divided into the following three cases:

First case. The current display mode is the display mode with pictures.

In the display mode with pictures, the browser of the mobile terminal normally downloads the text resources and the picture resources. Therefore, in the display mode with pictures, the browser of the mobile terminal renders the downloaded picture resources to the picture display area, and renders the downloaded text resources to the text display area, to obtain the specified web page.

Second case. The current display mode is the display mode without pictures.

In the display mode without pictures, the browser of the mobile terminal downloads the text resources, but does not download the picture resources. Therefore, in the display mode without pictures, the browser of the mobile terminal renders the downloaded text resources to the text display area, to obtain the specified web page.

Third case. The current display mode is the display mode without pictures in a data network.

In the display mode without pictures in a data network, if the current network status is a WiFi network, the browser of the mobile terminal may render the downloaded picture resources to the picture display area, and render the downloaded text resources to the text display area, to obtain the specified web page; if the current network status is a data network, and the local memory buffers all picture resources of the specified web page, the browser of the mobile terminal renders all buffered picture resources to the picture display area, and renders the downloaded text resources to the text display area, to obtain the specified web page; if the current network status is a data network, and the local memory does not buffer the picture resources of the specified web page, the browser of the mobile terminal renders the downloaded text resources to the text display area, to obtain the specified web page; if the current network status is a data network, and the local memory buffers some picture resources of the specified web page, the browser of the mobile terminal renders the downloaded text resources to the text display area, and renders the buffered picture resources to the corresponding picture display area, to obtain the specified web page.

111. The mobile terminal displays the specified web page.

The browser of the mobile terminal displays the rendered specified web page, to complete the displaying for the specified web page.

The foregoing uses the display process for the specified web page as an example, and for displaying of other web pages, reference may be made to the foregoing process. Certainly, when other web pages are displayed, if the display mode of the browser of the mobile terminal is the display mode with pictures, the other web pages are displayed according to the foregoing display manner of the display mode with pictures, if the display mode of the browser of the mobile terminal is the display mode without pictures, the other web pages are displayed according to the foregoing display manner of the display mode without pictures, and if the display mode of the browser of the mobile terminal is the display mode without pictures in a data network, the other web pages are displayed according to the foregoing display manner of the display mode without pictures in a data network.

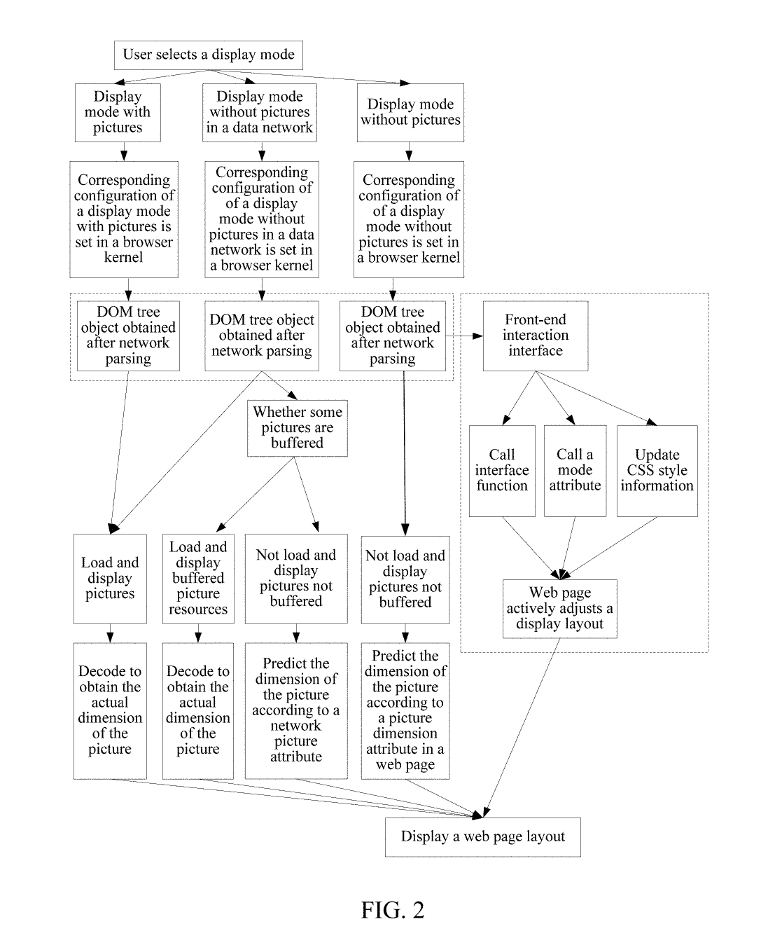

The foregoing process for the browser of the mobile terminal to display the specified web page is described in detail below from the product side with reference to FIG. 2.

(1) After the browser of the mobile terminal is started, the user may set the display mode of the browser on a browser interface, if the display mode selected by the user is the display mode with pictures, performs step (2), if the display mode selected by the user is the display mode without pictures in a data network, performs step (4), and if the display mode selected by the user is the display mode without pictures, performs step (7).

(2) The browser of the mobile terminal obtains a display mode parameter corresponding to the display mode with pictures, and transfers the display mode parameter corresponding to the display mode with pictures to an underlying kernel. When the user browses web pages, the browser of the mobile terminal parses the web pages by the using the underlying kernel, to at least generate DOM tree information, and further notifies the front end of the browser by using the front-end interaction interface, so that the front end of the browser may adjust the web page layout.

(3) The mobile terminal traverses the picture node information in the DOM tree information, downloads the picture resources in the picture nodes, after the picture resources are downloaded completely, decodes the downloaded picture resources, to obtain picture attribute information, and performs step (9).

(4) The browser of the mobile terminal obtains the display mode parameter corresponding to the display mode without pictures in a data network, and transfers the display mode parameter corresponding to the display mode without pictures in a data network to the underlying kernel. When the user browses web pages, the browser of the mobile terminal parses the web pages by the using the underlying kernel, to generate DOM tree information, and further notifies the front end of the browser by using the front-end interaction interface, so that the front end of the browser may adjust the web page layout.

(5) The browser of the mobile terminal determines a current network status, if the current network status is a WiFi network, performs step (3), and if the current network status is a data network, performs step (6), to further determine whether the local memory buffers picture resources of each picture node in the web pages.

(6) The browser of the mobile terminal traverses the picture node information in the DOM tree information, and determines whether the local memory buffers the picture resources of each picture node, if the local memory buffers the picture resources of each picture node, decodes the buffered picture resources; and if the local memory does not buffer the picture resources of each picture node, performs step (8).

(7) The browser of the mobile terminal obtains a display mode parameter corresponding to the display mode without pictures, and transfers the display mode parameter corresponding to the display mode without pictures to an underlying kernel. When the user browses web pages, the browser of the mobile terminal parses the web pages by the using the underlying kernel, to generate DOM tree information, and further notifies the front end of the browser by using the front-end interaction interface, so that the front end of the browser may adjust the web page layout.

(8) The browser of the mobile terminal traverses the picture node information in the DOM tree information, and in the process of traversing the picture node information in the DOM tree information, the browser of the mobile terminal does not download or decode the picture resources, but draws a shadow area as a picture display area of the picture resources according to the picture node information (the picture node information is the modified picture node information), and performs step (9).

(9) The browser of the mobile terminal renders the web pages according to the information (the DOM tree information, the style rule information, and the JavaScript execution result) obtained by parsing the web pages and an actual display area of the pictures, and displays the rendered web pages.

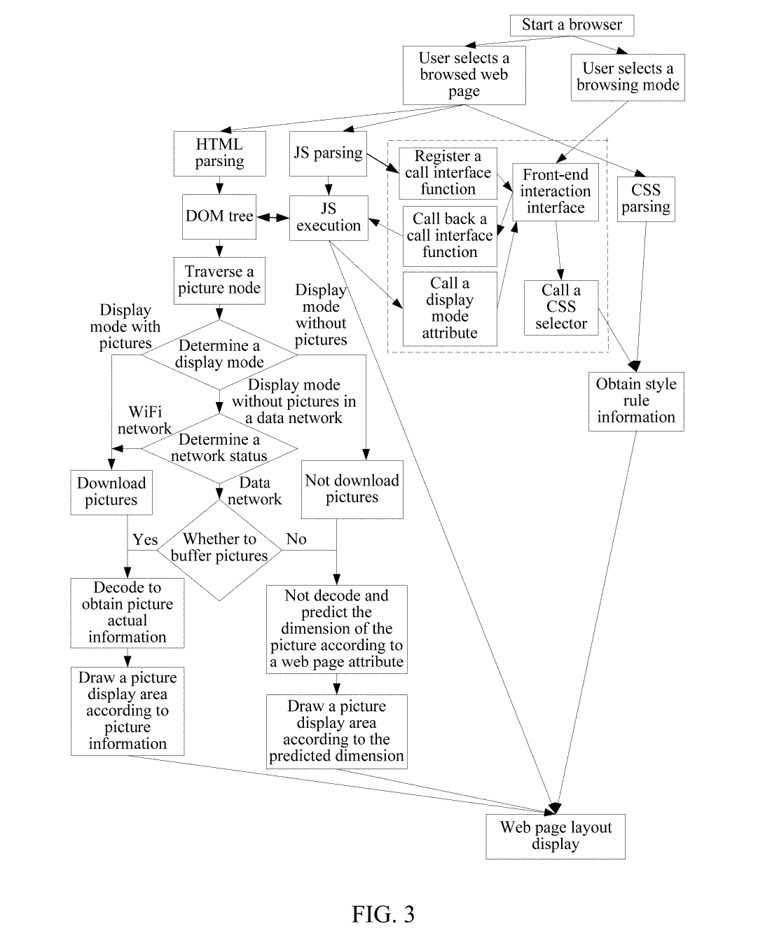

The foregoing process for the browser of the mobile terminal to display the specified web page is described below from the background implementation with reference to FIG. 3.

(a) After the browser of the mobile terminal is started, the user sets the display mode of the browser on a browser interface.

(b) The browser of the mobile terminal stores a display mode parameter corresponding to the display mode set by the user to a front-end interaction interface of the underlying kernel according to a setting operation of the user, so that when the user browses web pages, the web pages may be displayed according to the display mode set by the user.

(c) When the user clicks a to-be-browsed web page link, the browser of the mobile terminal generates a display request for the web pages, and performs steps (d), (l), and (0).

(d) The browser of the mobile terminal parses HTML information in the web page, to obtain DOM tree information of the web pages, and traverses all picture node information in the DOM tree information.

(e) The browser of the mobile terminal determines a current display mode according to the display mode parameter stored in the front-end interaction interface, if the current display mode is a display mode with pictures, performs step (f); if the current display mode is a display mode without pictures in a data network, performs step (h); and if the current display mode is the display mode without pictures, performs step (j).

(f) The browser of the mobile terminal downloads picture resources according to the picture node information in the DOM tree information, and downloads text resources according to the text node information in the DOM tree information.

(g) The browser of the mobile terminal decodes the downloaded picture resources, to obtain picture attribute information, draws a picture display area according to the picture attribute information, and performs step (0).

(h) The browser of the mobile terminal determines a current network status, if the current network status is a WiFi network, performs step (f); and if the current network is a data network, performs step (i) to perform further determining.

(i) The browser of the mobile terminal determines whether a local memory buffers picture resources in web pages, and if the local memory buffers the picture resources in the web pages, performs step (f); and if the local memory does not buffer the picture resources in the web pages, performs step (j).

(j) The browser of the mobile terminal does not download the picture resource.

(k) The browser of the mobile terminal determines an actual dimension of the picture according to the modified picture node information (see step (m) for a modification process), draws the picture display area by using gray as a fill color, and performs step (0).

(l) The browser of the mobile terminal parses JavaScript information in the web pages, to obtain JavaScript code, and registers a call interface function with the front-end interaction interface.

(m) The browser of the mobile terminal calls back the call interface function by using the front-end interaction interface to execute the JavaScript code, modifies the picture node information in the DOM tree information in a process of executing of the JavaScript code, and performs step (0).

(n) The browser of the mobile terminal parses CSS information in the web pages, to obtain multiple types of style rule information of the web pages, and the front-end interaction interface triggers a CSS selector, obtains style rule information corresponding to the current display mode from the multiple types of style rule information, and performs step (0).

(o) The browser of the mobile terminal renders a web page layout according to the DOM tree information, the JavaScript execution result, and the style rule information corresponding to the current display mode, renders the downloaded resources to a corresponding display area in the web page layout, obtains the web pages, and displays the web pages.

In the method provided in one embodiment of the present disclosure, a current display mode is determined, and style rule information corresponding to the current display mode is selected according to the current display mode, to meet display requirements in different display modes, and when JavaScript code is executed, picture node information in a DOM tree is modified, so that the modified picture node information is picture actual node information, and a picture display area determined according to the modified picture node information is more accurate. Therefore, the displayed web page layout is more reasonable according to the style rule information corresponding to the current display mode and the accurate display area, and the actual form of web pages can be reflected. Various display modes are provided, browsing requirements of users in different scenarios are met, and the user stickiness is increased.

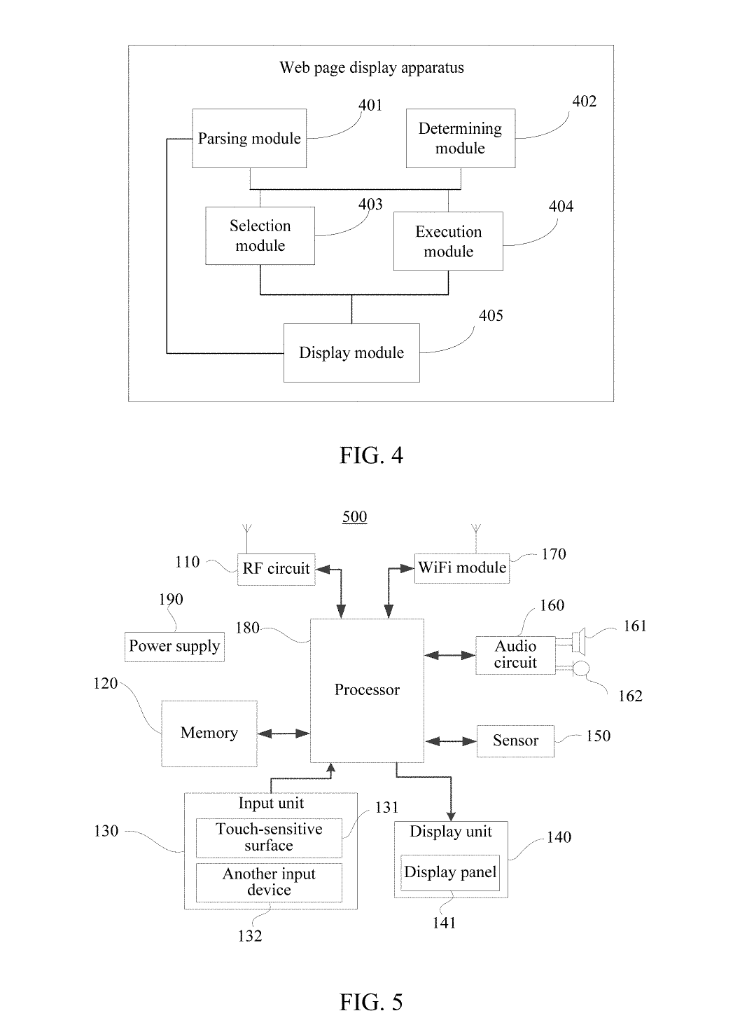

Referring to FIG. 4, an embodiment of the present disclosure provides a web page display apparatus, the apparatus is disposed in a mobile terminal, and the apparatus includes:

a parsing module 401, configured to parse source code of a specified web page requested to display, to obtain Document Object Model (DOM) tree information, JavaScript code, and at least two pieces of style rule information;

a determining module 402, configured to determine a current display mode;

a selection module 403, configured to select style rule information corresponding to the current display mode from the at least two pieces of style rule information;

an execution module 404, configured to execute the JavaScript code, to obtain a JavaScript execution result; and

a display module 405, configured to display the specified web page according to the DOM tree information, the JavaScript execution result, and the style rule information corresponding to the current display mode.

In one embodiment of the present disclosure, the apparatus further includes:

an obtaining module, configured to obtain a display mode parameter when a mode setting operation is detected on a browser interface; and

a sending module, configured to send the display mode parameter to an underlying kernel by using a preset front-end interaction interface for storage.

The determining module 402 is further configured to obtain the display mode parameter from the underlying kernel by using the front-end interaction interface; and determine the current display mode according to the display mode parameter.

In one embodiment of the present disclosure, the DOM tree information includes first picture node information, and the JavaScript code includes second picture node information.

The display module 405 is configured to modify the first picture node information according to the second picture node information in a process of triggering the execution of the JavaScript code, to obtain the modified DOM tree information; and display the specified web page according to the modified DOM tree information, the JavaScript execution result, and the style rule information corresponding to the current display mode.

In one embodiment of the present disclosure, the apparatus further includes:

a registration module, configured to register a call interface function with the front-end interaction interface; and

a function callback module, configured to call back the call interface function by using the front-end interaction interface.

The display module 405 is further configured to modify the first picture node information according to the second picture node information in a process of executing the JavaScript code by using the call interface function, to obtain the modified DOM tree information.

In one embodiment of the present disclosure, the display module 405 is further configured to predict a picture display area according to the first picture node information in the modified DOM tree information; and display a specified web page according to the modified DOM tree information, the picture display area, the JavaScript execution result, and the style rule information corresponding to the current display mode.

The device further includes:

a downloading module, configured to download resources of the specified web page according to the current display mode and the modified DOM tree information.

The display module 405 is further configured to render a specified web page layout according to the modified DOM tree information, the JavaScript execution result, and the style rule information corresponding to the current display mode; and render the downloaded resources of the specified web page to the specified web page layout, to obtain and display the specified web page.

In one embodiment of the present disclosure, the modified DOM tree information further includes text node information, and the downloading module is further configured to: when the current display mode is a display mode with pictures, download text resources of the specified web page according to the text node information in the modified DOM tree information; and download picture resources of the specified web page according to the first picture node information in the modified DOM tree information.

In one embodiment of the present disclosure, the modified DOM tree information further includes text node information, and the downloading module is further configured to: when the current display mode is a display mode without pictures, download text resources of the specified web page according to the text node information in the modified DOM tree information.

In one embodiment of the present disclosure, the modified DOM tree information further includes text node information, and the downloading module is further configured to: when the current display mode is a display mode without pictures in a data network, determine a current network status, the current network status including a data network and a WiFi (Wireless Fidelity) network; if the current network status is a WiFi network, download text resources of the specified web page according to the text node information in the modified DOM tree information, and download picture resources of the specified web page according to the first picture node information in the modified DOM tree information; if the current network status is a data network, determine whether a local memory buffers the picture resources of the specified web page; if the local memory buffers the picture resources of the specified web page, download the text resources of the specified web page according to the text node information in the modified DOM tree information, and obtain the buffered picture resources of the specified web page; and if the local memory does not buffer the picture resources of the specified web page, download the text resources of the specified web page according to the text node information in the modified DOM tree information.

In conclusion, a current display mode is determined, and style rule information corresponding to the current display mode is selected according to the current display mode, to meet display requirements in different display modes, and when JavaScript code is executed, picture node information in a DOM tree is modified, so that the modified picture node information is picture actual node information, and a picture display area determined according to the modified picture node information is more accurate. Therefore, the displayed web page layout is more reasonable according to the style rule information corresponding to the current display mode and the accurate display area, and the actual form of web pages can be reflected. Various display modes are provided, browsing requirements of users in different scenarios are met, and the user stickiness is increased.

Referring to FIG. 5, FIG. 5 shows a schematic structural diagram of a mobile terminal that displays a web page according to an embodiment of the present disclosure. The mobile terminal may be configured to implement the web page display method provided in the foregoing embodiments. Specifically:

The mobile terminal 500 may include components such as a Radio Frequency (RF) circuit 110, a memory 120 including one or more computer readable storage media, an input unit 130, a display unit 140, a sensor 150, an audio circuit 160, a Wireless Fidelity (WiFi) module 170, a processor 180 including one or more processing cores, and a power supply 190. A person skilled in the art may understand that the structure of the mobile terminal shown in FIG. 5 does not constitute a limitation to the mobile terminal, and the terminal may include more components or fewer components than those shown in the figure, or some components may be combined, or a different component deployment may be used.

The RF circuit 110 may be configured to receive and send signals during information receiving and sending or during a call. Particularly, the RF circuit 110 receives downlink information from a base station, then delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communication standard or protocol, including but not limited to Global System for Mobile communications (GSM), general packet radio service (GPRS), Code Division Multiple Access (CDMA), Wideband Code Division Multiple Access (WCDMA), Long Term Evolution (LTE), email, Short Messaging Service (SMS), and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the mobile terminal 500, and the like. In addition, the memory 120 may include a high speed random access memory, and may further include a non-volatile memory, such as at least one magnetic disk storage device, a flash memory, or other volatile solid-state storage devices. Correspondingly, the memory 120 may further include a memory controller, to provide access of the processor 180 and the input unit 130 to the memory 120.

The input unit 130 may be configured to receive input digit or character information, and generate a keyboard, mouse, joystick, optical or track ball signal input related to the user setting and function control. Specifically, the input unit 130 may include a touch-sensitive surface 131 and another input device 132. The touch-sensitive surface 131, which may also be referred to as a touch screen or a touch panel, may collect a touch operation of a user on or near the touch-sensitive surface (such as an operation of a user on or near the touch-sensitive surface 131 by using any suitable object or accessory, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives touch information from the touch detection apparatus, converts the touch information into touch point coordinates, and sends the touch point coordinates to the processor 180. Moreover, the touch controller can receive and execute a command sent by the processor 180. In addition, the touch-sensitive surface 131 may be a resistive, capacitive, infrared, or surface sound wave type touch-sensitive surface. In addition to the touch-sensitive surface 131, the input unit 130 may further include the another input device 132. Specifically, the another input device 132 may include, but is not limited to: one or more of a physical keyboard, a functional key (such as a volume control key or a switch key), a track ball, a mouse, and a joystick.

The display unit 140 may be configured to display information input by the user or information provided for the user, and various graphical user interfaces of the mobile terminal 500. The graphical user interfaces may be composed of graphics, text, icons, videos, and any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 141 transfers the touch operation to the processor 180, to determine the type of the touch event. Then, the processor 180 provides a corresponding visual output on the display panel 1241 according to the type of the touch event. Although, in FIG. 5, the touch-sensitive surface 131 and the display panel 141 are used as two separate parts to implement input and output functions, in some embodiments, the touch-sensitive surface 131 and the display panel 141 may be integrated to implement the input and output functions.

The mobile terminal 500 may further include at least one sensor 150 such as an optical sensor, a motion sensor, and other sensors. Specifically, the light sensor may include an ambient light sensor and a proximity sensor. The ambient light sensor may adjust luminance of the display panel 141 according to brightness of the ambient light. The proximity sensor may switch off the display panel 141 and/or backlight when the mobile terminal 500 is moved to the ear. As one type of motion sensor, a gravity acceleration sensor may detect magnitude of accelerations in various directions (which generally are triaxial), may detect magnitude and a direction of the gravity when static, and may be used for an application that recognizes the attitude of the mobile phone (for example, switching between landscape orientation and portrait orientation, a related game, and magnetometer attitude calibration), and a function related to vibration recognition (such as a pedometer and a knock). Other sensors, such as a gyroscope, a barometer, a hygrometer, a thermometer, and an infrared sensor, which may be configured in the mobile terminal 500 are not further described herein.

The audio circuit 160, a speaker 161, and a microphone 162 may provide audio interfaces between the user and the mobile terminal 500. The audio circuit 160 may convert received audio data into an electric signal and transmit the electric signal to the speaker 161. The speaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, to provide communication between a peripheral earphone and the terminal 500.

The WiFi is based on a short distance wireless transmission technology. The mobile terminal 500 may help, by using the WiFi module 170, the user to receive and send e-mails, browse a web page, access streaming media, and so on, which provides wireless broadband Internet access for the user. Although FIG. 5 shows the WiFi circuit 170, it may be understood that the wireless communications unit is not a necessary component of the mobile terminal 500, and when required, the wireless communications unit may be omitted as long as the scope of the essence of the present disclosure is not changed.

The processor 180 is a control center of the mobile terminal 500, which is connected to various parts of the entire mobile phone by using various interfaces and lines, and by running or executing a software program and/or module stored in the memory 120 and calling data stored in the memory 120, to perform various functions of the mobile terminal 500 and process data, so as to perform overall monitoring on the mobile phone. Optionally, the processor 180 may include the one or more processing cores. Optionally, the processor 180 may integrate an application processor and a modem. The application processor mainly processes an operating system, a user interface, an application program, and the like. The modem mainly processes wireless communication. It may be understood that the foregoing modem processor may alternatively not be integrated into the processor 180.

The mobile terminal 500 further includes the power supply 190 (such as a battery) for supplying power to the components. Preferably, the power supply may be logically connected to the processor 180 by using a power management system, thereby implementing functions such as charging, discharging, and power consumption management by using the power management system. The power supply 190 may further include one or more of a direct current or alternating current power supply, a re-charging system, a power failure detection circuit, a power supply converter or inverter, a power supply state indicator, and any other components.

Although not shown in the figure, the mobile terminal 500 may further include a camera, a Bluetooth module, and the like, which are not described herein. Specifically, in one embodiment of the present disclosure, the display unit of the mobile terminal 500 is a touch screen display, the mobile terminal 500 further includes a memory, the memory is configured to store at least one instruction, at least one program, and a code set or an instruction set, and the at least one instruction, and the at least one program, the code set or the instruction set are loaded by the processor 180 to perform the web page display method shown in FIG. 1.

In the terminal provided in one embodiment of the present disclosure, a current display mode is determined, and style rule information corresponding to the current display mode is selected according to the current display mode, to meet display requirements in different display modes, and when JavaScript code is executed, picture node information in a DOM tree is modified, so that the modified picture node information is picture actual node information, and a picture display area determined according to the modified picture node information is more accurate. Therefore, the displayed web page layout is more reasonable according to the style rule information corresponding to the current display mode and the accurate display area, and the actual form of web pages can be reflected. Various display modes are provided, browsing requirements of users in different scenarios are met, and the user stickiness is increased.

An embodiment of the present disclosure further provides a storage medium, and the storage medium may be a computer readable storage medium in the memory in the foregoing embodiments; or may a storage medium that exists independently, and is not assembled in the terminal. The storage medium stores at least one instruction, at least one program, and a code set or an instruction set, and the at least one instruction, the at least one program, and the code set or the instruction set are loaded by the processor to implement the web page display method shown in FIG. 1.

In the storage medium provided in one embodiment of the present disclosure, a current display mode is determined, and style rule information corresponding to the current display mode is selected according to the current display mode, to meet display requirements in different display modes, and when JavaScript code is executed, picture node information in a DOM tree is modified, so that the modified picture node information is picture actual node information, and a picture display area determined according to the modified picture node information is more accurate. Therefore, the displayed web page layout is more reasonable according to the style rule information corresponding to the current display mode and the accurate display area, and the actual form of the web page can be reflected. Various display modes are provided, browsing requirements of users in different scenarios are met, and the user stickiness is increased.

An embodiment of the present disclosure provides a graphical user interface, the graphical user interface is used at a web page display terminal, the web page display terminal includes a touch screen display, a memory, and one or more processors configured to execute one or more programs. The graphical user interface is configured to implement the web page display method shown in FIG. 1.

In the graphical user interface provided in one embodiment of the present disclosure, a current display mode is determined, and style rule information corresponding to the current display mode is selected according to the current display mode, to meet display requirements in different display modes, and when JavaScript code is executed, picture node information in a DOM tree is modified, so that the modified picture node information is picture actual node information, and a picture display area determined according to the modified picture node information is more accurate. Therefore, the displayed web page layout is more reasonable according to the style rule information corresponding to the current display mode and the accurate display area, and the actual form of web pages can be reflected. Various display modes are provided, browsing requirements of users in different scenarios are met, and the user stickiness is increased.

It should be noted that: when the web page display apparatus and the mobile terminal configured to display a web page are displaying the web page according to the foregoing embodiments of the present disclosure, only divisions of the foregoing functional modules are described by using an example. In actual application, the foregoing functions may be completed by allocating to different functional modules according to a need, that is, internal structures of the web page display apparatus and the mobile terminal configured to display a web page are divided into different functional modules, to complete all or a part of the foregoing described functions. In addition, the web page display apparatus and the mobile terminal configured to display a web page according to the foregoing embodiments of the present disclosure and the embodiment of the web page display method belong to one concept. For specific implementation procedures, refer to the method embodiments, and details are not described herein again.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the embodiments of the present disclosure, but are not intended to limit the embodiments of the present disclosure. Any modification, equivalent replacement, or improvement made within the spirit and principle of the embodiments of the present disclosure shall fall within the protection scope of the embodiments of the present disclosure.

What is claimed is:

1. A web page display method, comprising:
parsing, by a mobile terminal, source code of a specified web page requested to display, to obtain Document Object Model (DOM) tree information, JavaScript code, and at least two pieces of style rule information;
determining, by the mobile terminal, a current display mode;
selecting, by the mobile terminal, style rule information corresponding to the current display mode from the at least two pieces of style rule information;
executing, by the mobile terminal, the JavaScript code, to obtain a JavaScript execution result; and
displaying, by the mobile terminal, the specified web page according to the DOM tree information, the JavaScript execution result, and the style rule information corresponding to the current display mode.

2. The method according to claim 1, wherein before the parsing, by a mobile terminal, source code of a specified web page requested to display, to obtain Document Object Model (DOM) tree information, JavaScript code, and at least two pieces of style rule information, the method further comprises:
obtaining, by the mobile terminal, a display mode parameter in response to detecting a mode setting operation on a browser interface; and
sending, by the mobile terminal, the display mode parameter to an underlying kernel by using a preset front-end interaction interface for storage; and
wherein the determining, by the mobile terminal, a current display mode comprises:
obtaining, by the mobile terminal, the display mode parameter from the underlying kernel by using the front-end interaction interface; and
determining, by the mobile terminal, the current display mode according to the display mode parameter.

3. The method according to claim 1, wherein the DOM tree information comprises first picture node information, and the JavaScript code comprises second picture node information; and
the displaying, by the mobile terminal, the specified web page according to the DOM tree information, the JavaScript execution result, and the style rule information corresponding to the current display mode comprises:
modifying, by the mobile terminal, the first picture node information according to the second picture node information in a process of executing the JavaScript code, to obtain a modified DOM tree information; and
displaying, by the mobile terminal, the specified web page according to the modified DOM tree information, the JavaScript execution result, and the style rule information corresponding to the current display mode.

4. The method according to claim 3, wherein the modifying, by the mobile terminal, the first picture node information according to the second picture node information in a process of executing the JavaScript code, to obtain the modified DOM tree information comprises:
registering, by the mobile terminal, a call interface function with the front-end interaction interface;
calling back, by the mobile terminal, the call interface function by using the front-end interaction interface; and
modifying, by the mobile terminal, the first picture node information according to the second picture node information in a process of executing the JavaScript code by using the call interface function, to obtain the modified DOM tree information.

5. The method according to claim 3, wherein the displaying, by the mobile terminal, the specified web page according to the modified DOM tree information, the JavaScript execution result, and the style rule information corresponding to the current display mode comprises:
determining, by the mobile terminal, a picture display area according to the first picture node information in the modified DOM tree information; and
displaying, by the mobile terminal, the specified web page according to the modified DOM tree information, the picture display area, the JavaScript execution result, and the style rule information corresponding to the current display mode.

6. The method according to claim 3, wherein after the determining, by the mobile terminal, a current display mode, the method further comprises:
downloading, by the mobile terminal, resources of the specified web page according to the current display mode and the modified DOM tree information; and
the displaying, by the mobile terminal, the specified web page according to the modified DOM tree information, the JavaScript execution result, and the style rule information corresponding to the current display mode comprises:
rendering, by the mobile terminal, a specified web page layout according to the modified DOM tree information, the JavaScript execution result, and the style rule information corresponding to the current display mode; and
rendering, by the mobile terminal, the downloaded resources of the specified web page to the specified web page layout, to obtain and display the specified web page.

7. The method according to claim 6, wherein the modified DOM tree information further comprises text node information, and the downloading, by the mobile terminal, resources of the specified web page according to the current display mode and the modified DOM tree information comprises:
when the current display mode is a display mode with pictures, downloading, by the mobile terminal, text resources of the specified web page according to the text node information in the modified DOM tree information; and
downloading, by the mobile terminal, picture resources of the specified web page according to the first picture node information in the modified DOM tree information.

8. The method according to claim 6, wherein the modified DOM tree information further comprises text node information, and the downloading, by the mobile terminal, resources of the specified web page according to the current display mode and the modified DOM tree information comprises:
when the current display mode is a display mode without pictures, downloading, by the mobile terminal, text resources of the specified web page according to the text node information in the modified DOM tree information.

9. The method according to claim 6, wherein the modified DOM tree information further comprises text node information, and the downloading, by the mobile terminal, resources of the specified web page according to the current display mode and the modified DOM tree information comprises:
when the current display mode is a display mode without pictures in a cellular data network, determining, by the mobile terminal, a current network status, the current network status comprising cellular data network connection and WiFi (Wireless Fidelity) network connection;
if the current network status is WiFi network connection, downloading, by the mobile terminal, text resources of the specified web page according to the text node information in the modified DOM tree information, and downloading picture resources of the specified web page according to the first picture node information in the modified DOM tree information;
if the current network status is cellular data network connection, determining, by the mobile terminal, whether the picture resources of the specified web page are buffered in a local memory;
if the picture resources of the specified web page are buffered in the local memory, downloading, by the mobile terminal, the text resources of the specified web page according to the text node information in the modified DOM tree information, and obtaining the buffered picture resources of the specified web page; and
if the picture resources of the specified web page are not buffered in the local memory, downloading, by the mobile terminal, the text resources of the specified web page according to the text node information in the modified DOM tree information.

10. A web page display apparatus, comprising:
a memory; and
a processor coupled to the memory and configured to:
parse source code of a specified web page requested to display, to obtain Document Object Model (DOM) tree information, JavaScript code, and at least two pieces of style rule information;
determine a current display mode;
select style rule information corresponding to the current display mode from the at least two pieces of style rule information;
execute the JavaScript code, to obtain a JavaScript execution result; and
display the specified web page according to the DOM tree information, the JavaScript execution result, and the style rule information corresponding to the current display mode.

11. The apparatus according to claim 10, wherein the processor is further configured to:
obtain a display mode parameter when a mode setting operation is detected on a browser interface;
send the display mode parameter to an underlying kernel by using a preset front-end interaction interface for storage;
obtain the display mode parameter from the underlying kernel by using the front-end interaction interface; and
determine the current display mode according to the display mode parameter.

12. The apparatus according to claim 10, wherein the DOM tree information comprises first picture node information, and the JavaScript code comprises second picture node information; and
the processor is configured to modify the first picture node information according to the second picture node information in a process of triggering the execution of the JavaScript code, to obtain a modified DOM tree information; and display the specified web page according to the modified DOM tree information, the JavaScript execution result, and the style rule information corresponding to the current display mode.

13. The apparatus according to claim 12, wherein the processor is further configured to:
register a call interface function with the front-end interaction interface; and
call back the call interface function by using the front-end interaction interface, wherein
modify the first picture node information according to the second picture node information in a process of executing of the JavaScript code by using the call interface function, to obtain the modified DOM tree information.

14. The apparatus according to claim 12, wherein the processor is further configured to determine a picture display area according to the first picture node information in the modified DOM tree information; and display the specified web page according to the modified DOM tree information, the picture display area, the JavaScript execution result, and the style rule information corresponding to the current display mode.

15. The apparatus according to claim 12 or 14, wherein the processor is further configured to:
download resources of the specified web page according to the current display mode and the modified DOM tree information, wherein
render a specified web page layout according to the modified DOM tree information, the JavaScript execution result, and the style rule information corresponding to the current display mode; and render the downloaded resources of the specified web page to the specified web page layout, to obtain and display the specified web page.

16. The apparatus according to claim 15, wherein the modified DOM tree information further comprises text node information, and the processor is further configured to: when the current display mode is a display mode with pictures, download text resources of the specified web page according to the text node information in the modified DOM tree information; and download picture resources of the specified web page according to the first picture node information in the modified DOM tree information.

17. The apparatus according to claim 15, wherein the modified DOM tree information further comprises text node information, and the processor is further configured to: when the current display mode is a display mode without pictures, download text resources of the specified web page according to the text node information in the modified DOM tree information.

18. The apparatus according to claim 15, wherein the modified DOM tree information further comprises text node information, and the processor is further configured to:
when the current display mode is a display mode without pictures in a cellular data network, determine a current network status, the current network status comprising cellular data network connection and WiFi (Wireless Fidelity) network connection;
if the current network status is a WiFi network connection, download text resources of the specified web page according to the text node information in the modified DOM tree information, and download picture resources of the specified web page according to the first picture node information in the modified DOM tree information;
if the current network status is a cellular data network connection, determine whether the picture resources of the specified web page are buffered in a local memory;
if the picture resources of the specified web page are buffered in the local memory, download the text resources of the specified web page according to the text node information in the modified DOM tree information, and obtain the buffered picture resources of the specified web page; and
if the picture resources of the specified web page are not buffered in the local memory, download the text resources of the specified web page according to the text node information in the modified DOM tree information.

19. A non-transitory storage medium storing computer program instructions executable by at least one processor to perform:
parsing source code of a specified web page requested to display, to obtain Document Object Model (DOM) tree information, JavaScript code, and at least two pieces of style rule information;
determining a current display mode;
selecting style rule information corresponding to the current display mode from the at least two pieces of style rule information;
executing the JavaScript code, to obtain a JavaScript execution result; and
displaying the specified web page according to the DOM tree information, the JavaScript execution result, and the style rule information corresponding to the current display mode.

20. The storage medium according to claim 19, wherein the DOM tree information comprises first picture node information, and the JavaScript code comprises second picture node information; and
the displaying, by the mobile terminal, the specified web page according to the DOM tree information, the JavaScript execution result, and the style rule information corresponding to the current display mode comprises:
modifying, by the mobile terminal, the first picture node information according to the second picture node information in a process of executing the JavaScript code, to obtain a modified DOM tree information; and
displaying, by the mobile terminal, the specified web page according to the modified DOM tree information, the JavaScript execution result, and the style rule information corresponding to the current display mode.
